(19) United States
(12) Patent Application Publication
(10) Pub. No.: US 2022/0374799 A1
(43) Pub. Date: Nov. 24, 2022

(54) DISPLAY CONTROL DEVICE, AND DISPLAY CONTROL METHOD

(71) Applicant: Nippon Telegraph and Telephone Corporation, Tokyo (JP)

(72) Inventors: Sayaka Yagi, Musashino-shi, Tokyo (JP); Kimio Tsuchikawa, Musashino-shi, Tokyo (JP); Takeshi Masuda, Musashino-shi, Tokyo (JP); Fumihiro YOKOSE, Musashino-shi, Tokyo (JP); Yuki Urabe, Musashino-shi, Tokyo (JP)

(21) Appl. No.: 17/771,523

(22) PCT Filed: Oct. 30, 2019
(86) PCT No.: PCT/JP2019/042690

§ 371 Date: Apr. 25, 2022

(51) Int. Cl. G06Q 10/06

(52) U.S. Cl. CPC G06Q 10/0637

(57) ABSTRACT

A display control device (10) includes a display processing unit (12) configured to read an operational log file and generate a first object indicating operation information visualized by a predetermined visual representation of a first operation entity, and second objects each indicating operation information of a second operation entity that is different in granularity from the first operation entity, a visualization unit (13) configured to perform drawing based on the first object and perform display on a screen, and a summary information generation unit (14) configured to generate summary information in which second objects corresponding to a selected part are grouped, when any part of the first object displayed on the screen is selected. The visualization unit (13) displays the summary information while superimposing or associating the summary information on or with a designated area.

### TECHNICAL FIELD

The present invention relates to a display control device and a display control method.

### BACKGROUND ART

In general, the approach frequently taken in business improvement processes of a company includes first grasping actual business situations by hearings using man power, work amount estimation by observation/time measurements, and the like, and then considering improvement plans after finding problematic portions. However, grasping the actual business situations through hearings or the like requires a significant amount of work. In addition, it may be biased toward the subjectivities and procedures of some analysts, and there are problems in accuracy, comprehensiveness, and the like.

Therefore, there is a conventionally proposed method in which an operational log of a terminal is acquired and visualized so that actual business situations can be grasped more efficiently, in a wide range, and finely in granularity.

Among operational log visualization methods, the timeline in which the time axis is set in an x-axis direction on a screen, each row in a y-axis direction is an element (e.g., user), and the duration of the element is expressed by a rectangle is known as an effective method for grasping operational situations on a terminal in the business analysis. For example, Non-Patent Literature 1 proposes a method for hierarchically arranging an operational log with information of the same granularity such as user, application, window, operation, and the like, and visualizing a timeline. In addition, another method for displaying an operation on the timeline and a captured image while associating them with each other is proposed (e.g., refer to Non-Patent Literature 2).

### CITATION LIST

### Non-Patent Literature

Non-Patent Literature 1: Sayaka YAGI, Kimio TUCHIKAWA, Fumihiro YOKOSE, Yuki URABE, Takeshi MASUDA, “Study of an interactive grouping method for timeline-based operational log visualization”, IEICE technical report, vol. 119, no. 111, ICM2019-13, pp. 41-46, July 2019.
Non-Patent Literature 2: Phong H. Nguyen et al., “SensePath: Understanding the Sensemaking Process through Analytic Provenance”, IEEE transactions on visualization and computer graphics, vol. 22, no. 1, pp. 41-50, 2016.

### SUMMARY OF THE INVENTION

### Technical Problem

However, in the existing timeline display method (Non-Patent Literature 1), it was impossible to overview another hierarchy (e.g., operation) at the same time when observing a specific hierarchy (e.g., application or window). Further, in the method for displaying the operation on the timeline and the captured image while associating them with each other (Non-Patent Literature 2), it was difficult to overview the details of the operation although individual operational contents and the operational flow in the selected time zone can be observed from the captured image and the animation display of an operation sequence in the selected range.

As mentioned above, according to the conventional methods, an operation entity (e.g., application or window) concerned by an analyst and other operation entities cannot be displayed at the same time. Therefore, according to the conventional method, it is necessary to repeat hierarchy expansion operations, hierarchy contraction operations, individual image confirmation operations, and the like in order to find problematic portions and pursue the causes of the problems, which makes it difficult to perform the analysis efficiently.

The present invention has been made in view of the foregoing, and intends to provide a display control device and a display control method capable of efficiently analyzing actual business situations based on an operational log of a terminal.

### Means for Solving the Problem

To solve the above-mentioned problems and achieve the purpose, a display control device according to the present invention is characterized by including a generation unit configured to read an operational log file and generate a first object indicating operation information visualized by a predetermined visual representation of a first operation entity, about the first operation entity, and second objects each indicating operation information of a second operation entity that is different in granularity from the first operation entity, a visualization unit configured to perform drawing based on the first object and perform display on a screen, and a summary information generation unit configured to generate summary information in which second objects corresponding to a selected part are grouped, when any part of the first object displayed on the screen is selected, wherein the visualization unit displays the summary information while superimposing or associating the summary information on or with a designated area.

Further, a display control method according to the present invention is a display control method that is executed by a display control device. The method is characterized by including a process for reading an operational log file and generating a first object indicating operation information visualized by a predetermined visual representation of a first operation entity, about the first operation entity, and second objects each indicating operation information of a second operation entity that is different in granularity from the first operation entity, a process for performing drawing based on the first object and performing display on a screen, a process for generating summary information in which second objects corresponding to a selected part are grouped, when any part of the first object displayed on the screen is selected, and a process for displaying the summary information while superimposing or associating the summary information on or with a designated range.

### Effects of the Invention

According to the present invention, actual business situations can be efficiently analyzed based on an operational log of a terminal.

### BRIEF DESCRIPTION OF DRAWINGS

FIG. 1 is a diagram illustrating an exemplary functional configuration of a display control device according to an embodiment.

FIG. 2 is a diagram illustrating an exemplary data configuration of an operational log.

FIG. 3 is a diagram illustrating an exemplary timeline displayed on a screen output unit.

FIG. 4 is a diagram illustrating an exemplary timeline displayed on the screen output unit.

FIG. 5 is a diagram illustrating an exemplary timeline displayed on the screen output unit.

FIG. 6 is a diagram illustrating an exemplary operation history image.

FIG. 7 is a diagram illustrating another exemplary data configuration of the operational log.

FIG. 8 is a diagram illustrating another exemplary operation history image.

FIG. 9 is a diagram illustrating another exemplary timeline displayed on the screen output unit.

FIG. 10 is a diagram illustrating another exemplary operation history image displayed on the screen output unit.

FIG. 11 is a flowchart illustrating a processing procedure of display control processing according to an embodiment.

FIG. 12 is a diagram illustrating an exemplary computer that can realize the display control device by executing a program.

### DESCRIPTION OF EMBODIMENTS

Hereinafter, an embodiment of the present invention will be described in detail with reference to the drawings. The present invention is not limited to the embodiments. Further, in the description of the drawings, the same parts are indicated by the same reference numerals.

### Embodiment

First, a display control device according to an embodiment will be described. The display control device according to the present embodiment visualizes an operational log indicating operational contents for a window of a terminal (not illustrated) screen in a timeline format, in order to analyze actual business situations of a user using the terminal. For example, in the timeline, the time axis is taken in the x-axis direction on the screen, elements configuring the data are arranged in the y-axis direction, and a time zone in which each element corresponding to the row on the y axis appears is displayed as a horizontally long rectangle.

Then, when an analyst selects a part of the timeline, the display control device according to the present embodiment superimposes and displays an operation history image, in which the operation history corresponding to the selected part is displayed on a captured image that indicates a window screen in which the above operation has been performed while the operation history is superimposed or associated on or with the captured image, as a summary image, on the timeline. As mentioned above, the present embodiment can streamline the analysis on the actual business situation by the analyst by making it possible to overview the details of the operation at the same time as the outline of the operation.

[Configuration of Display Control Device]

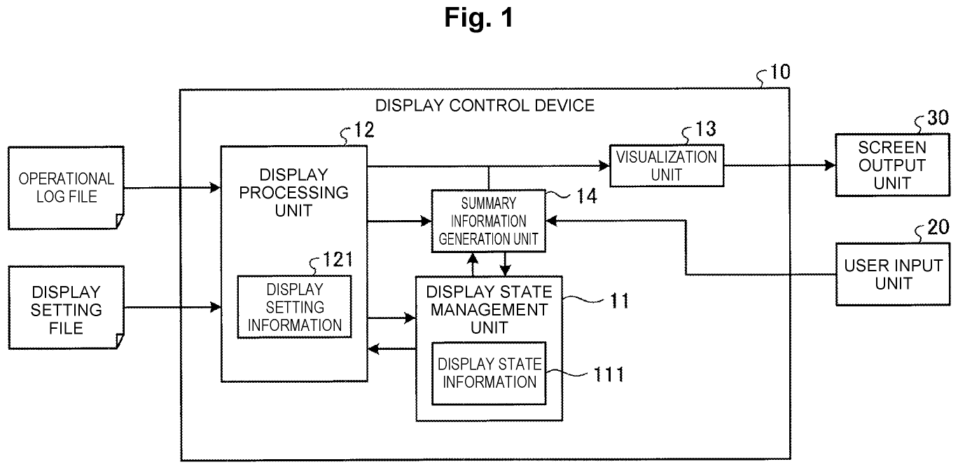

FIG. 1 is a diagram illustrating an exemplary functional configuration of the display control device according to an embodiment. As illustrated in FIG. 1, a display control device 10 according to the present embodiment is connected to a user input unit 20 that receives an operation of an analyst and a screen output unit 30 that outputs a screen. The display control device 10 accepts the input of an operational log file and a display setting file indicating initial screen display settings.

The operational log file includes information logs of a plurality of operation entities. The operational log is, for example, information indicating terminal information, login user information, application information, window information, and operational contents, and occurrence time. The window information is, for example, window title, URL/file path, window handle, and the like. The operational contents are, for example, operation target, operation type, value, captured image, and the like, and are recorded when an operation for an object in the window occurs.

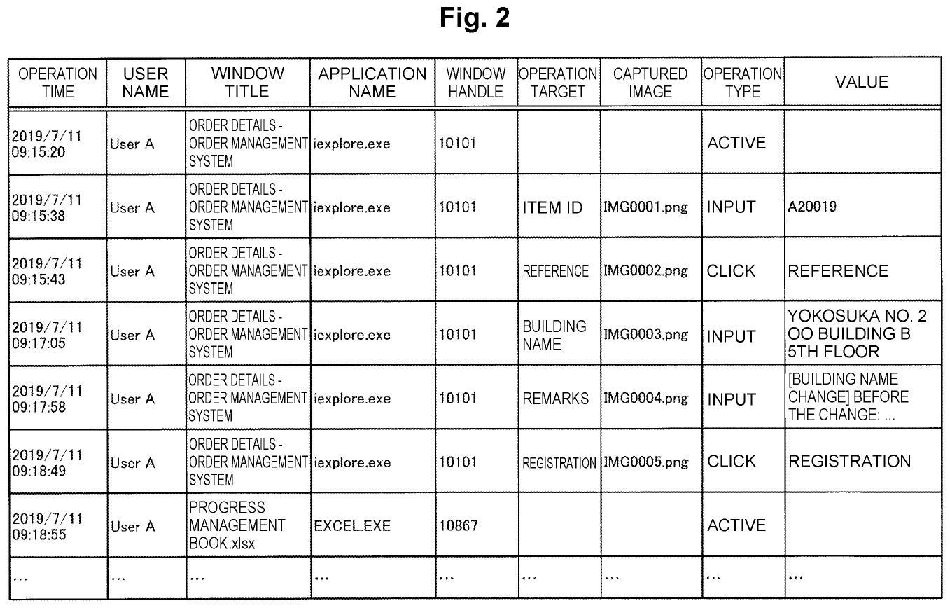

FIG. 2 is a diagram illustrating an exemplary data configuration of the operational log. As illustrated in FIG. 2, the operational log includes information recorded when the window state on a terminal screen is changed, namely, window-based information such as user operation time in the window, user name, operation target window title, application name used in the window, and window handle. In addition to the above information, the operational log includes information recorded when an operation on an object in the window occurs, namely, information of an operation entity such as operation target, operation time for the object, captured image of the window operated during the operation time, operation type, value input by the operation, and the like. The change in the window state is a change in the active state of the window, a change in the title or URL, or the like. The operation target is information such as an input field name that identifies the operation target, and is identified by different information for each graphical user interface (GUI) component in the operation target window. In the case of a browser, ID or name attribute of a document object model (DOM) object may be used.

The display control device 10 can be realized, for example, by a computer or the like that includes a read-only memory (ROM), a random-access memory (RAM), a central processing unit (CPU), or the like, when a predetermined program is read and the CPU executes the predetermined program. Further, the display control device 10 has a communication interface that transmits and receives various information to and from other devices connected via a network or the like. For example, the display control device 10 has a network interface card (NIC) or the like, and communicates with other devices via an electric telecommunication line such as a local area network (LAN) or the Internet. The display control device 10 has a display state management unit 11, a display processing unit (generation unit) 12, a visualization unit 13, and a summary information generation unit 14.

The display state management unit 11 manages display state information 111 that indicates an arrangement structure of row objects. The display state information 111 is information generated by the display processing unit 12, and is updated upon generation of new display state information by the display processing unit 12. The row object (first object) is a constituent component of the timeline, and is an object that collects records in which data items other than the time stamp match in the user's operational log on the terminal screen.

The display processing unit 12 has display setting information 121. The display setting information 121 is setting information related to the timeline display. The display setting information 121 is information for setting items to be displayed, information indicating a hierarchical structure, and objects to be displayed. The display setting information 121 is generated based on the display setting file indicating the initial screen display settings, for example, according to analyst instruction information from the user input device 20.

Here, the hierarchy is a collection of elements belonging to the same data item or an entity (e.g., group or period) set by the user among elements configuring user's operational contents indicated in the operational log or the like. The group is a collection of arbitrary elements focused on, of the user's operational contents.

The display processing unit 12 reads the operational log, and generates objects configuring the timeline according to the display setting information 121. The display processing unit 12 generates row objects. The row object is an object indicating operation information visualized by a predetermined visual representation, more specifically, two-dimensional visual representation, of a first operation entity, about the first operation entity. The row objects correspond to records that match in user name, operation target window title, as well as application name and window handle used in this window.

The display processing unit 12 reads the operational log, and generates operation objects (second objects) each indicating information of an operation entity. The operation object is an object indicating operation information of a second operation entity different in granularity from the first operation entity. The operation objects are information indicating operating user name, operation target window title, operation type, operation time, operation occurrence time (operation time), and the like.

The display processing unit 12 creates the display state information 111 in which generated row objects are hierarchically arranged, based on hierarchy settings described in the display setting information 121. The display state information 111 is information indicating the arrangement position of row objects representing window-based operation information, of the operational log, on the screen of the screen output unit 30. The display state information 111 includes information on each row object (e.g., data item, value, or the like that are keys of the row object), in addition to the entire row object hierarchical structure. The display state information 111 includes operation object arrangement information. The display processing unit 12, when it generates the display state information 111, transmits the display state information 111 to the visualization unit 13.

The visualization unit 13 determines the arrangement of the row objects on the y axis of the timeline, based on the display state information 111 generated by the display processing unit 12, and further determines attribute values such as hue and transparency of the rectangles expressing the row objects, and then generates the objects (including rectangles, labels, axes, and the like) configuring the timeline. Then, the visualization unit 13 outputs the generation results to the screen output unit 30 such as a display. Specifically, based on the row objects and the hierarchical structure, the visualization unit 13 draws rectangles configuring the hierarchically arranged timeline and displays them on the screen.

Further, the visualization unit 13 generates plots indicating the operations based on occurrence times of the operation objects. Then, the visualization unit 13 superimposes and displays the plots on the rectangles expressing the row objects so as to correspond to the occurrence times when the operations have been performed.

When the range of any one of the row objects displayed on the screen is selected, the summary information generation unit 14 generates summary information in which the operation objects corresponding to the selected part are grouped.

When any one of the rectangles displayed on the screen is selected, the summary information generation unit 14 acquires records collected by the row object expressed by this rectangle from the read operational log. Then, based on window information included in the acquired records, the summary information generation unit 14 groups objects included in the start-to-end time of the selected range, of operation objects executed in the window. Then, the summary information generation unit 14 generates, as summary information, an operation history image including a directed graph in which each operation target is indicated by a node and the operation order is indicated by links between the nodes, being superimposed and displayed on a captured image indicating a window screen in which the operation has been performed. Here, the grouping is to collect the operation objects included in the user's selected range. The operation objects of the same group correspond to the operation history image, and each node corresponds to a result of aggregating objects (records) whose operation targets are the same, in the grouped operation objects. The visualization unit 13 superimposes and displays this summary information in the designated range on the displayed timeline.

[Flow of Display Control Processing]

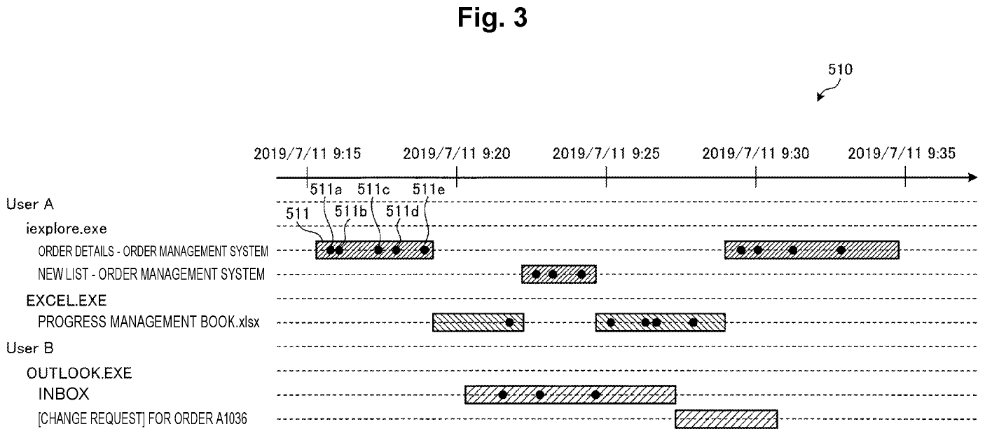

Subsequently, the flow of display control processing in the display control device 10 will be described. FIG. 3 to FIG. 5 are diagrams illustrating exemplary timelines displayed on the screen output unit 30.

The display processing unit 12 reads the operational log illustrated in FIG. 2 and generates objects that configure the timeline. The display processing unit 12 generates the display state information 111, in which row objects are hierarchically arranged, based on the hierarchy settings described in the display setting information 121. The visualization unit 13 determines the arrangement of objects (rectangles, labels, axes, or the like) on the y axis of the timeline based on the display state information 111, and further determines attribute values such as hue and transparency of the rectangles expressing the row objects, and then performs drawing.

As a result, as illustrated in FIG. 3, a timeline 510 hierarchically arranged in the order of user name—application name—window title is displayed on the screen. For example, a rectangle 511 indicates that User A has referred to a window titled as “ORDER DETAILS—ORDER MANAGEMENT SYSTEM”, using iexplore.exe, in the duration from 2019/7/11 09:15:20 to 2019/7/11 09:18:55.

Then, based on the read operational log, the display processing unit 12 generates operation objects indicating the operation entity from the record containing operational contents. For example, the display processing unit 12 generates operation objects indicating information of input operations or click operations by the User A for an order details window in the duration from 2019/7/11 09:15:20 to 2019/7/11 09:18:55. The generated operation objects indicate an input operation 1 executed on 2019/7/11 09:15:38, a click operation 2 executed on 2019/7/11 09:15:43, an input operation 3 executed on 2019/7/11 09:17:05, an input operation 4 executed on 2019/7/11 09:17:58, and a click operation 5 executed on 2019/7/11 09:18:49.

Then, based on the operation objects generated by the display processing unit 12, the visualization unit 13 generates plots 511a to 511e indicating the input operation 1, the click operation 2, the input operations 3 and 4, and the click operation 5, respectively. The visualization unit 13 superimposes and draws the plots 511a to 511e so as to correspond to their occurrence times, on the rectangle 511. As a result, the plots each indicating the execution of the operation are displayed in the timeline. The display control device 10 may distinguish the operation type, the operation target, and the like according to the shape and color of the plot. Further, the plot display can be switched between display and non-display by an GUI operation or the like. In the plot display, the switching between display and non-display can be performed in a lump, or the switching between display and non-display can be performed for each user, each operational content, or the like.

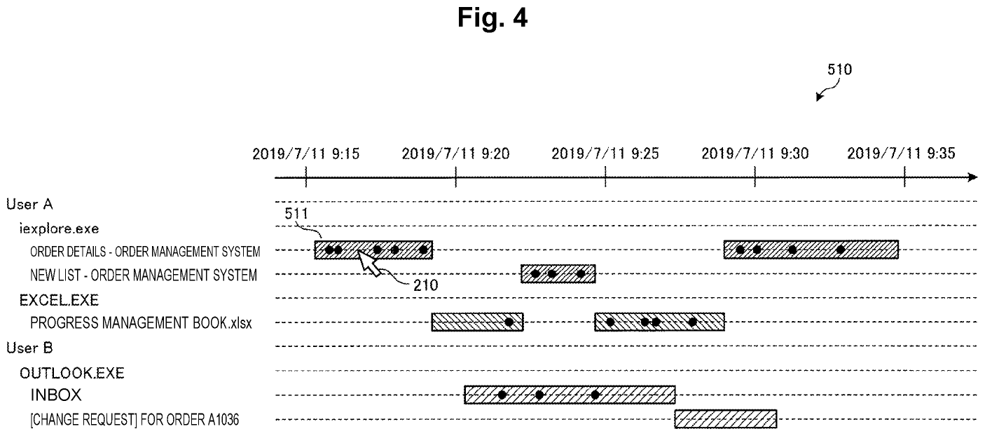

Subsequently, when a mouse over, a click operation, or the like is executed on the timeline according to an analyst operation on the user input device 20, the display control device 10 displays an operation history image of the corresponding part as summary information. An exemplary case of FIG. 4 in which the rectangle 511 is selected by a cursor 210 as a click operation is performed will be described.

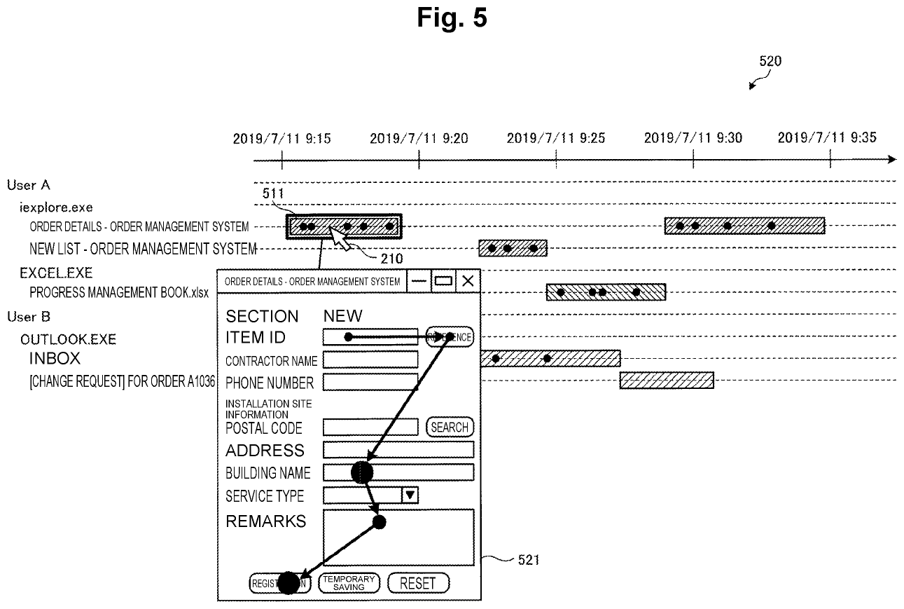

In this case, as illustrated in FIG. 5, the display control device 10 generates an operation history image 521 indicating the history of operations performed in the order details window during the period indicated by the rectangle 511, and displays the operation history image 521 in association with the area in the vicinity of the rectangle 511. A display area of the operation history image 521 is an area adjacent to the selected rectangle and is an area designated in advance.

In this case, the display control device 10 acquires a captured image of the window screen operated in the period of the selected rectangle 511 part and the operation history, from the operational log. Then, the display control device 10 generates and displays an operation history image in which the operation history at the time corresponding to the selected rectangle 511 is superimposed on the acquired captured image. According to the example illustrated in FIG. 5, the display control device 10 displays the captured image (the operation history image 521) including a superimposed directed graph in which the operation target is indicated by a node, the detention time is indicated by the node size, and the operation order is indicated by links, while associating the captured image with the rectangle 511.

The operation history image 521 is generated by the summary information generation unit 14. Here, the processing for generating the operation history image 521 by the summary information generation unit 14 will be described.

First, upon receiving an input of a rectangle selected on the timeline, the summary information generation unit 14 identifies the start time, the end time, and the hierarchy of the selected rectangle and identifies an operation sequence included in this range from the operation objects. The summary information generation unit 14 identifies the number of operation target windows included in the identified operation sequence. Of the operation sequence, the summary information generation unit 14 regards the operations different in window information as being different in the operation target window. Then, regarding the operations having the common window information, the summary information generation unit 14 regards images included in different clusters due to the clustering of captured images as being different in the operation target window, for example.

Subsequently, the summary information generation unit 14 aggregates the time, the number of operations, and the like required in the operation for the same operation target, for each operation target window. The summary information generation unit 14 generates an operation history image including a superimposed and displayed directed graph in which the same operation target is indicated by a node and the operation order is indicated by links, for the captured image corresponding to each operation target window.

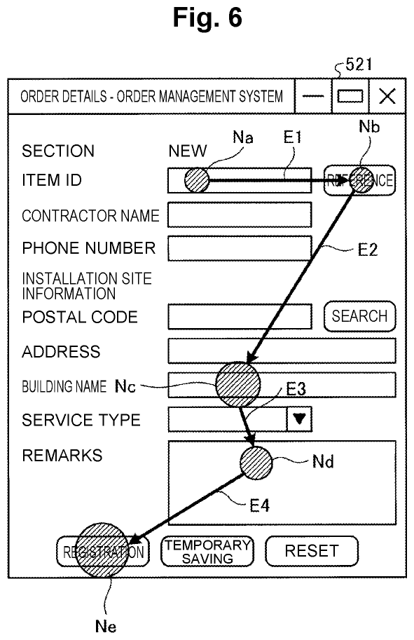

FIG. 6 is a diagram illustrating an exemplary operation history image. As illustrated in an operation history image 520 of FIG. 6, nodes Na to Ne indicating respective operations are superimposed and displayed on the operation positions where these operations have been actually performed, for the captured image. The directions of arrows representing links E1 to E4 indicate the operation order.

For example, the summary information generation unit 14 can visually express time-consuming operations, in addition to the operation order, by distinguishing the detention time with the node size and displaying the operation order with links. The summary information generation unit 14 may distinguish and display the number of operations with the hue, brightness, or the like of the node so as to visually express time-consuming operations.

The summary information generation unit 14 calculates the detention time by subtracting the previous operation time from the next operation time. Further, the summary information generation unit 14 generates the operation history image 520 using information of operation time—captured image, of the operational log illustrated in FIG. 2. The summary information generation unit 14 uses the values of the operation type and the operational log, when expressing the operation type, the value type, or the like with the color of the node or the like.

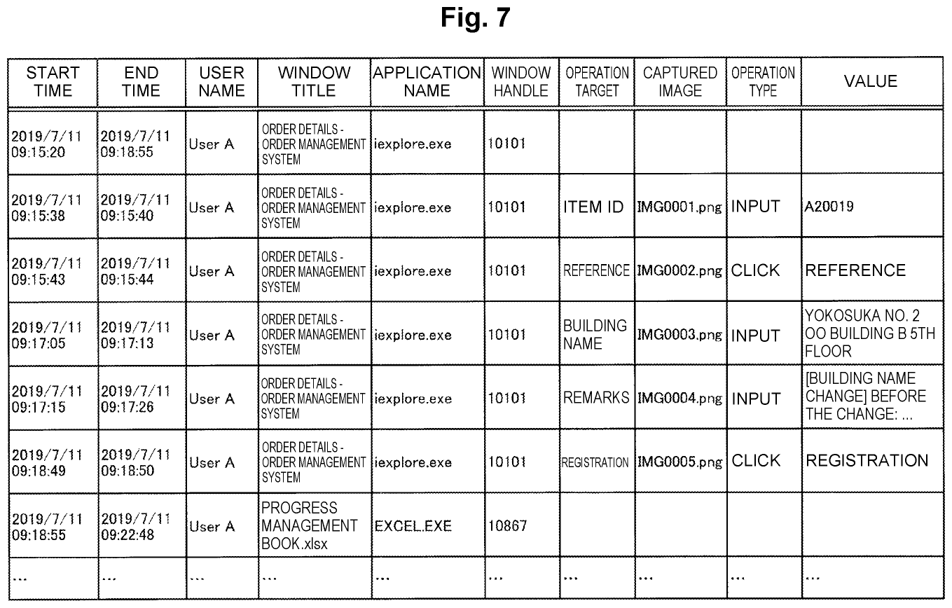

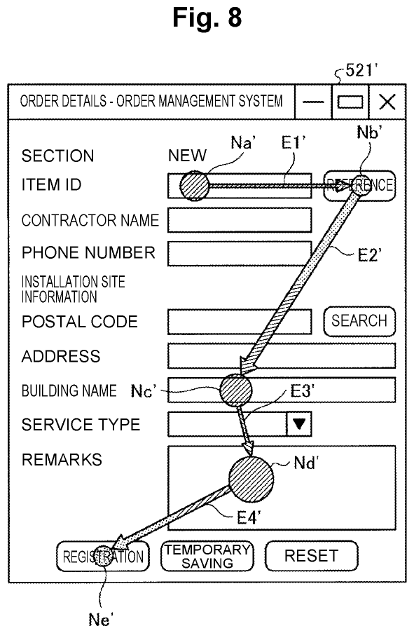

FIG. 7 is a diagram illustrating another exemplary data configuration of the operational log. FIG. 8 is a diagram illustrating another exemplary operation history image. In the case of the operational log illustrated in FIG. 7, the operation time is defined by the start time and the end time. The start time is the time when the operation target is focused. The end time is the time when the operation target is released from the focused state. The summary information generation unit 14 generates an operation history image 521′ (refer to FIG. 8) using information of start time—operation type, of the operational log illustrated in FIG. 7. The summary information generation unit 14 uses the values of the operational log, when expressing the value type or the like with the shape and color of the node or the like.

The operation history image 521′ includes a directed graph superimposed on the captured image. In the directed graph, nodes Na′ to Ne′ indicate respective operations, the size of each of the nodes Na′ to Ne′ indicates the detention time, the color of each of the nodes Na′ to Ne′ indicates the operation type, links E1′ to E4′ indicate the operation order, and the thickness of each of the link E1′ to E4′ indicates the transition time. As mentioned above, the summary information generation unit 14 can visually express time-consuming operations, longer transition time operations, or the like, by distinguishing the detention time with the node size, distinguishing and displaying the operation type with the hue, brightness, or the like of the node, and displaying the transition time with the thickness of the link.

The summary information generation unit 14 calculates the detention time by subtracting the start time from the end time. Further, the summary information generation unit 14 calculates the transition time by subtracting the end time of the previous operation from the start time of the next operation.

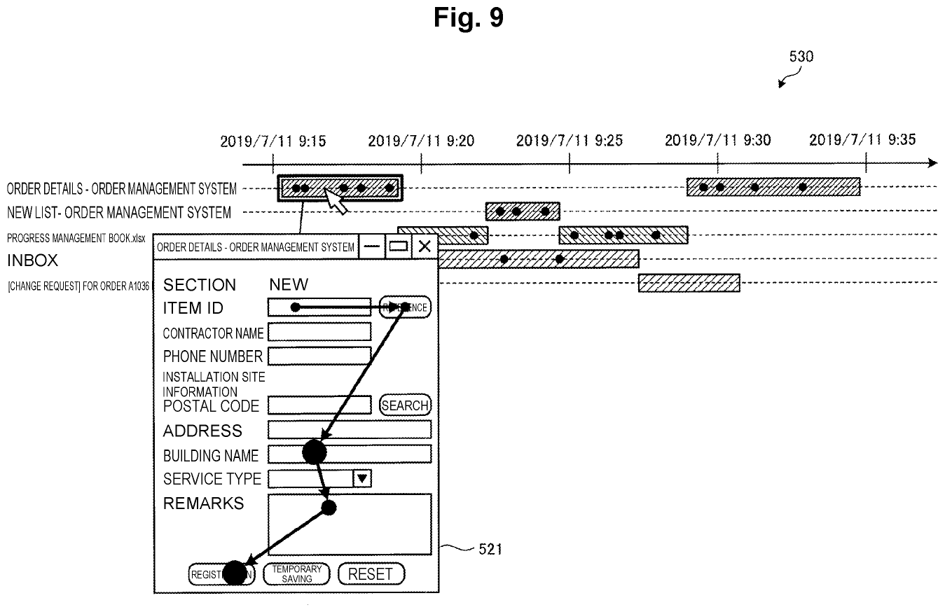

FIG. 9 is a diagram illustrating another exemplary timeline displayed on the screen output unit 30. Although the exemplary timelines of FIG. 3 to FIG. 5 have hierarchical structures, the display results are not limited to the illustrated examples. As illustrated in a timeline 530 of FIG. 9, the display control device 10 can display the plots together with the operation history image 521 even on the timeline including the display of some items (hierarchy) being set in advance from the terminal information, login user information, application information, and window information. In this case, the display control device 10 can omit the information indicating the hierarchical structure from the display setting information 121.

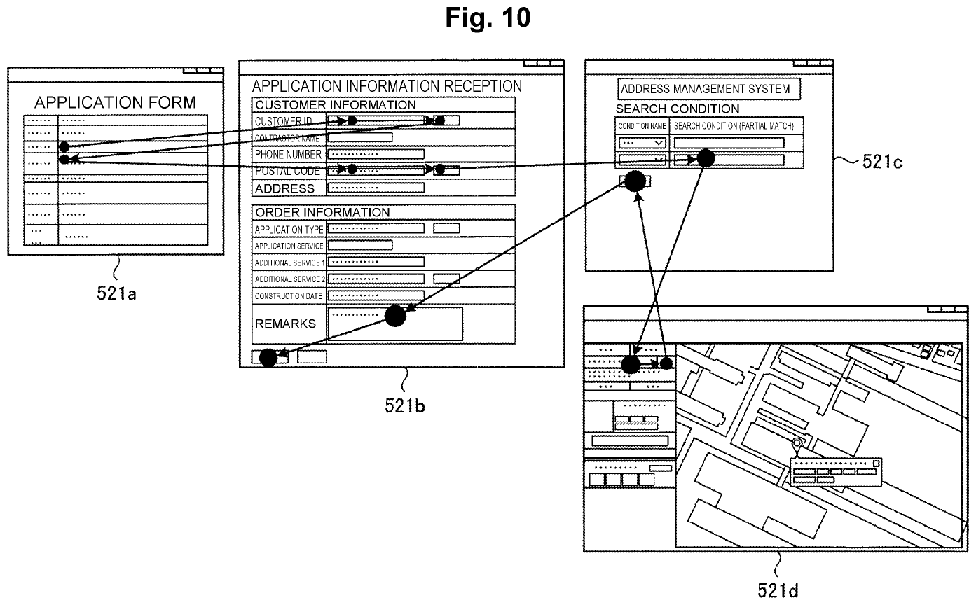

According to the examples of FIGS. 4 to 5 and FIG. 9, the selection operation for a single rectangle is illustrated exemplarily, but the range may be selected so as to include a plurality of rectangles. FIG. 10 is a diagram illustrating another exemplary operation history image displayed on the screen output unit. In this case, as illustrated in FIG. 10, operation history images are generated so that operation histories are superimposed with nodes and links on respective captured images 521a to 521d corresponding to a plurality of operation target windows included in the selected range. Further, the range may be selected so as to include a part of the rectangle.

[Processing Procedure of Display Control Processing]

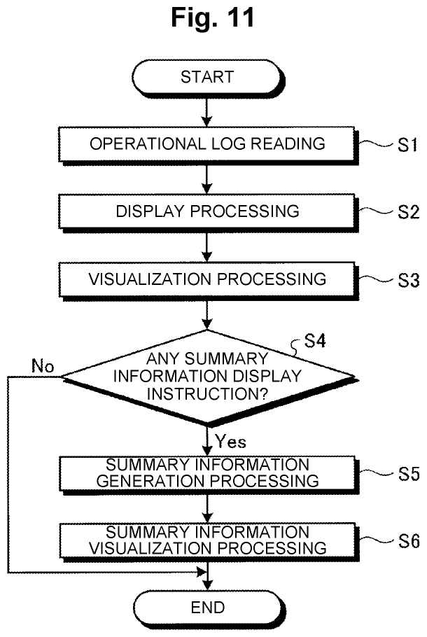

Next, with reference to FIG. 11, a processing procedure of display control processing that the display control device 10 executes will be described. FIG. 11 is a flowchart illustrating the processing procedure of the display control processing according to an embodiment.

As illustrated in FIG. 11, the display control device 10 reads an operational log to be displayed (step S1).

Then, according to the display setting information 121, the display processing unit 12 generates row objects configuring a timeline and performs display processing for generating operation objects (step S2). The visualization unit 13, the display processing unit 12 perform drawing based on the row objects and the operation objects generated by the display processing unit 12, and perform visualization processing for displaying the timeline on the screen (step S3).

The summary information generation unit 14 determines whether there is a summary information display instruction (step S4). When any rectangle expressing the row objects displayed on the screen is selected, the summary information generation unit 14 determines to be instructed to generate summary information being operation history information during the period indicated by this rectangle. When the summary information display instruction is not present (No in step S4), the display control device generates no summary information and continues to display the timeline.

When the summary information display instruction is present (Yes in step S4), the summary information generation unit 14 performs summary information generation processing for generating summary information in which the operation objects corresponding to the selected part are grouped (step S5). In step S6, the summary information generation unit 14 generates, as summary information, an operation history image indicating the history of operations performed in the displayed window during the period indicated by the selected rectangle. The visualization unit 13 performs summary information visualization processing for superimposing and displaying the summary information at a designated area on the displayed timeline (step S6). In step S6, the visualization unit 13 displays the operation history image in association with the area in the vicinity of the selected rectangle.

### Effects of Embodiment

As mentioned above, the display control device 10 according to the embodiment displays summary information of another hierarchy so as to be superimposed or associated on or with the hierarchy that is concerned by an analyst on the timeline. Specifically, the display control device 10 displays the operation history included in a predetermined range, as a captured image-based operation history image, so as to be associated with the application or the timeline displayed on the window basis, for example. Alternatively, the display control device 10 plots the occurrence times of respective operations on the timeline, based on the information of an operation entity (occurrence time, operation target, operation type, value, captured image, or the like).

As a result, the analyst can grasp the summary information of another hierarchy while displaying the hierarchy that is concerned by the analyst on the timeline, and therefore it is easy to narrow down the portion to be deeply analyzed. Therefore, the display control device 10 can reduce troublesome works by the analyst such as hierarchy expansion operations, contraction operations, individual image confirmations, and can improve the efficiency in business analysis. Accordingly, using the display control device 10 enables the analyst to efficiently analyze actual business situations based on an operational log of a terminal.

[System Configuration of Embodiment]

Each constituent component of the display control device 10 illustrated in FIG. 1 is functionally conceptual, and is not always required to be physically configured as illustrated in the drawing. That is, the specific decentration/integration form of the functions of the display control device 10 is not limited to the illustrated ones, and the whole or a part of the configuration can be functionally or physically decentralized/integrated, at arbitrary units, according to various load and usage situations.

Further, all or some of the pieces of processing to be performed in the display control device 10 may be realized by a CPU, a graphics processing unit (GPU), and programs that are analyzed and executed by the CPU and the GPU. Further, each piece of processing performed in the display control device 10 may be realized as wired logic hardware.

Further, of the pieces of processing described in the embodiment, all or some of them described as being automatically performed can be manually performed, or all or some of them described as being manually performed can be automatically performed by a known method. In addition, processing procedures, control procedures, and specific names, and information including various data and parameters in the above description and drawings can be arbitrarily changed unless otherwise specified.

[Program]

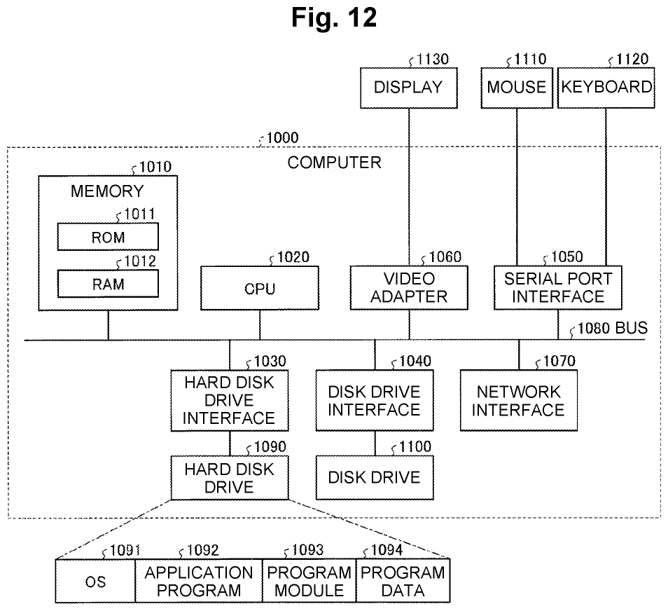

FIG. 12 is a diagram illustrating an exemplary computer that can realize the display control device 10 by executing a program. A computer 1000 includes, for example, a memory 1010 and a CPU 1020. Further, the computer 1000 includes a hard disk drive interface 1030, a disk drive interface 1040, a serial port interface 1050, a video adapter 1060, and a network interface 1070. These units are connected by a bus 1080.

The memory 1010 includes a ROM 1011 and a RAM 1012. The ROM 1011 stores, for example, a boot program such as basic input output system (BIOS). The hard disk drive interface 1030 is connected to a hard disk drive 1090. The disk drive interface 1040 is connected to a disk drive 1100. For example, a detachable storage medium such as a magnetic disk or an optical disc can be inserted into the disk drive 1100. The serial port interface 1050 is, for example, connected to a mouse 1110 and a keyboard 1120. The video adapter 1060 is, for example, connected to a display 1130.

The hard disk drive 1090 stores an operating system (OS) 1091, an application program 1092, a program module 1093, and a program data 1094, for example. That is, the program that defines each piece of processing of the display control device 10 is implemented as the program module 1093 in which codes are described so as to be executed by the computer 1000. The program module 1093 is, for example, stored in the hard disk drive 1090. For example, the program module 1093 for executing processing similar to the functional configuration of the display control device 10 is stored in the hard disk drive 1090. The hard disk drive 1090 may be replaced by a solid state drive (SSD).

Further, the setting data to be used in the processing of the above-mentioned embodiments is stored, as the program data 1094, in the memory 1010 or the hard disk drive 1090, for example. Then, the CPU 1020 reads, into the RAM 1012, the program module 1093 or the program data 1094 stored in the memory 1010 or the hard disk drive 1090 when needed, and executes it.

The program module 1093 and the program data 1094 are not limited to those stored in the hard disk drive 1090, and may be stored, for example, in a detachable storage medium so that the CPU 1020 can read out the program module 1093 and the program data 1094 via the disk drive 1100 or the like. Alternatively, the program module 1093 and the program data 1094 may be stored in another computer connected via a network such as a local area network (LAN) or a wide area network (WAN). Then, the CPU 1020 may read out the program module 1093 and the program data 1094 from another computer via the network interface 1070.

Although the embodiments to which the present invention made by the present inventor is applied have been described above, the present invention is not limited by the description and drawings serving as a part of the disclosure of the present invention based on the embodiments. That is, the present invention encompasses all of other embodiments, examples, operational techniques, and the like made by those skilled in the art based on the present embodiments.

### REFERENCE SIGNS LIST

10 Display control device
11 Display state management unit
12 Display processing unit
13 Visualization unit
14 Summary information generation unit
20 User input unit
30 Screen output unit
111 Display state information
121 Display setting information

1. A display control device comprising:
a generation unit, including one or more processors, configured to read an operational log and generate a first object indicating operation information visualized by a predetermined visual representation of a first operation entity, and second objects each indicating operation information of a second operation entity that is different in granularity from the first operation entity;
a visualization unit, including one or more processors, configured to perform drawing based on the first object and perform display on a screen; and
a summary information generation unit, including one or more processors, configured to generate summary information in which second objects corresponding to a selected part are grouped, when any part of the first object displayed on the screen is selected,
wherein the visualization unit is configured to display the summary information while superimposing or associating the summary information on or with a designated area.

2. The display control device according to claim 1, wherein the first object is a row object configuring a timeline.

3. The display control device according to claim 1, wherein the summary information generation unit is configured to group second objects corresponding to the selected part based on window information included in the operational log, and generate, as summary information, an operation history image including a directed graph in which an aggregate result of objects whose operation targets are the same, among the grouped second objects, is indicated by nodes and an operation order is indicated by links between the nodes, being superimposed and displayed on a captured image indicating a window screen in which the operation has been performed.

4. The display control device according to claim 1, wherein the visualization unit is configured to display the second object so as to be superimposed or associated on or with the first object.

5. A display control method that is executed by a display control device, comprising:
reading an operational log file and generating a first object indicating operation information visualized by a predetermined visual representation of a first operation entity, and second objects each indicating operation information of a second operation entity that is different in granularity from the first operation entity;
performing drawing based on the first object and performing display on a screen;
generating summary information in which second objects corresponding to a selected part are grouped, when any part of the first object displayed on the screen is selected; and
a process for displaying the summary information while superimposing or associating the summary information on or with a designated range.

6. The display control method according to claim 5, wherein the first object is a row object configuring a timeline.

7. The display control method according to claim 5, further comprising:
grouping second objects corresponding to the selected part based on window information included in the operational log; and
generating, as summary information, an operation history image including a directed graph in which an aggregate result of objects whose operation targets are the same, among the grouped second objects, is indicated by nodes and an operation order is indicated by links between the nodes, being superimposed and displayed on a captured image indicating a window screen in which the operation has been performed.

8. The display control method according to claim 5, further comprising displaying the second object so as to be superimposed or associated on or with the first object.

9. A non-transitory computer readable medium storing one or more instructions causing a computer to execute:
reading an operational log file and generating a first object indicating operation information visualized by a predetermined visual representation of a first operation entity, and second objects each indicating operation information of a second operation entity that is different in granularity from the first operation entity;
performing drawing based on the first object and performing display on a screen;
generating summary information in which second objects corresponding to a selected part are grouped, when any part of the first object displayed on the screen is selected; and
displaying the summary information while superimposing or associating the summary information on or with a designated range.

10. The non-transitory computer readable medium according to claim 9, wherein the first object is a row object configuring a timeline.

11. The non-transitory computer readable medium according to claim 9, causing the computer to execute:
grouping second objects corresponding to the selected part based on window information included in the operational log; and
generating, as summary information, an operation history image including a directed graph in which an aggregate result of objects whose operation targets are the same, among the grouped second objects, is indicated by nodes and an operation order is indicated by links between the nodes, being superimposed and displayed on a captured image indicating a window screen in which the operation has been performed.

12. The non-transitory computer readable medium according to claim 9, causing the computer to execute:
displaying the second object so as to be superimposed or associated on or with the first object.
